(19) United States
(12) Patent Application Publication
(10) Pub. No.: US 2013/0127082 A1
(43) Pub. Date: May 23, 2013

(54) Manufacturing Method of 3D Patterned Foam Sheet

(71) Applicant: Chao-Kai Wang, Dapi Township (TW)

(72) Inventor: Chao-Kai Wang, Dapi Township (TW)

(21) Appl. No.: 13/301,244

(22) Filed: Nov. 21, 2011

(51) Int. Cl. B28B 1/14

(52) U.S. Cl. 264/45.1; 264/41

(57) ABSTRACT

In a manufacturing method of 3D patterned foam sheet, a foaming material is placed in a foaming mold for a foaming process, and the foaming mold has lines in a predetermined pattern formed on upper and lower walls of the foaming mold, such that after the foaming material is formed, the foaming sheet with the lines in a predetermined pattern can be produced, and matching molds engaged with each other can be used for an extrusion, and the pattern formed on the foam sheet is twisted, and a 3D stylish model with a shape matched to the shape of the mold is formed on the foam sheet.

### BACKGROUND OF THE INVENTION

1. Field of the Invention

The present invention relates to a manufacturing method of foam sheet thereof, in particular to a manufacturing method of 3D patterned foam sheet thereof.

2. Description of the Related Art

Heretofore, the known manufacturing method of 3D form sheet is to have a forming sheet mold for foam sheet first, then press the form sheet with rolling wheel, heat the form sheet to settable temperature prior to roll, then press and roll the form sheet for desired 3D shapes.

Above method can make 3D foam sheets, however, due to the surface is very smooth without anti-slippery effect, the level of anti-slippery is not satisfactory. Furthermore, the pre-heating effect prior to rolling can only apply to the surface of foam sheet, the whole body is not heated and soft evenly, and that introduces difficulty to mold. Heat process after forming causes form sheet stick to rolling wheel easily which further causes protuberance on the surface of form sheet that damages the out looking.

### SUMMARY OF THE INVENTION

In view of the aforementioned problems of the prior art, it is a primary objective of the present invention to provide a manufacturing method of 3D patterned foam sheet thereof to have excellent anti-slippery effect.

It is another objective of the present invention to provide a manufacturing method of 3D patterned foam sheet thereof capable of easy to shape and assure surface of form sheet remains complete.

To achieve the foregoing objective, the present invention provides a manufacturing method of 3D patterned foam sheet, comprising the steps of:
a. Forming procedure: foaming material is placed in a foaming mold for the foaming process, and the foaming mold has lines in a predetermined pattern formed on upper and lower walls of the foaming mold, such that after the foaming material is formed, the foam sheet with the lines in a predetermined pattern can be produced;
b. Compress and shaping procedure: the formed and not fully cool form sheet is removed from the forming mold, and is compressed with a pair of matching molds, the molds have predetermined convex on the contact surfaces with the form sheet; the pattern formed on the foam sheet is twisted, and a 3D stylish model with a shape matched to the shape of the matching mold is formed on the surface of foam sheet.

Furthermore, after procedure b, a trim procedure follows to remove the compressed and shaped form sheet from mold and cut the form sheet into half in the middle by a cutting tool, such that to achieve rapid manufacturing goal.

### BRIEF DESCRIPTION OF THE DRAWINGS

FIG. 1 is a flow chart of a manufacturing method of 3D patterned foam sheet in accordance with the first preferred embodiment of the present invention;

FIG. 2 is a perspective view of a form sheet of a manufacturing method of 3D patterned foam sheet in accordance with the first preferred embodiment of the present invention;

FIG. 3 is a flow chart of a manufacturing method of 3D patterned foam sheet in accordance with the second preferred embodiment of the present invention;

FIG. 4 is a perspective view of a form sheet of a manufacturing method of 3D patterned foam sheet in accordance with the second preferred embodiment of the present invention;

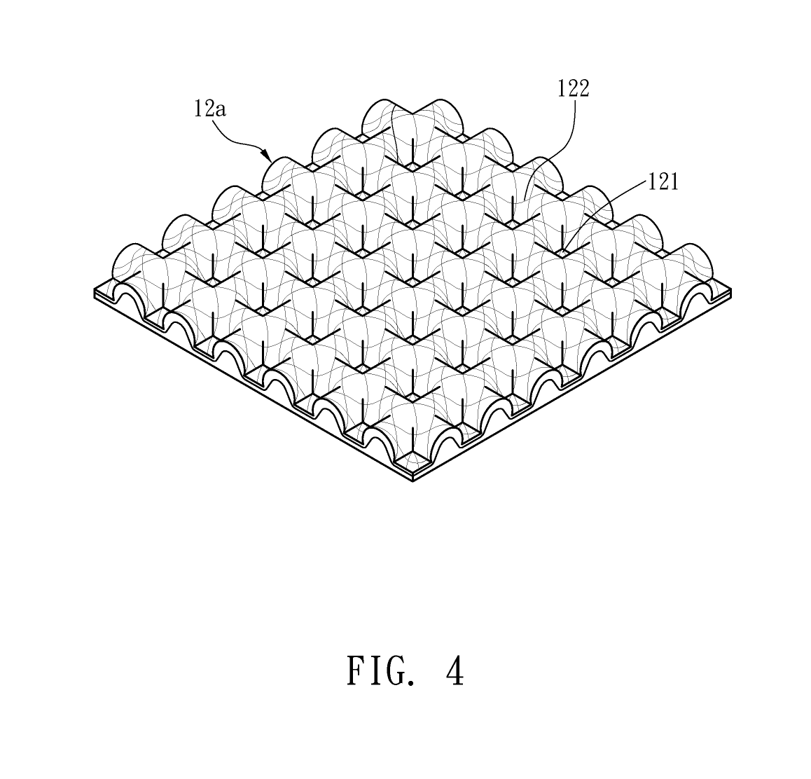

FIG. 5 is a perspective view of a mold with predetermined pattern convex of a manufacturing method of 3D patterned foam sheet of the present invention; and

FIG. 6 is a flow chart of a manufacturing method of 3D patterned foam sheet in accordance with the third preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

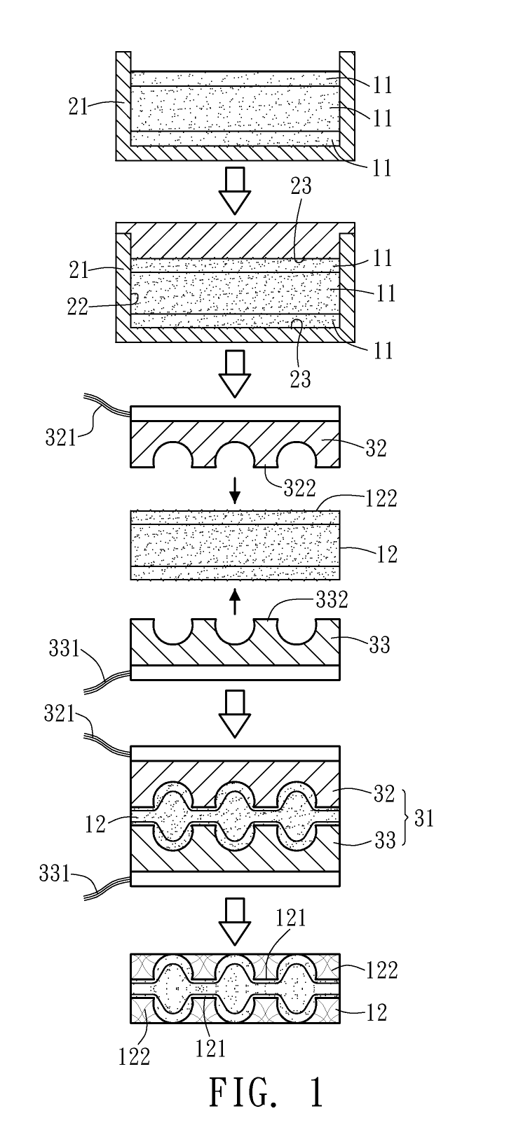

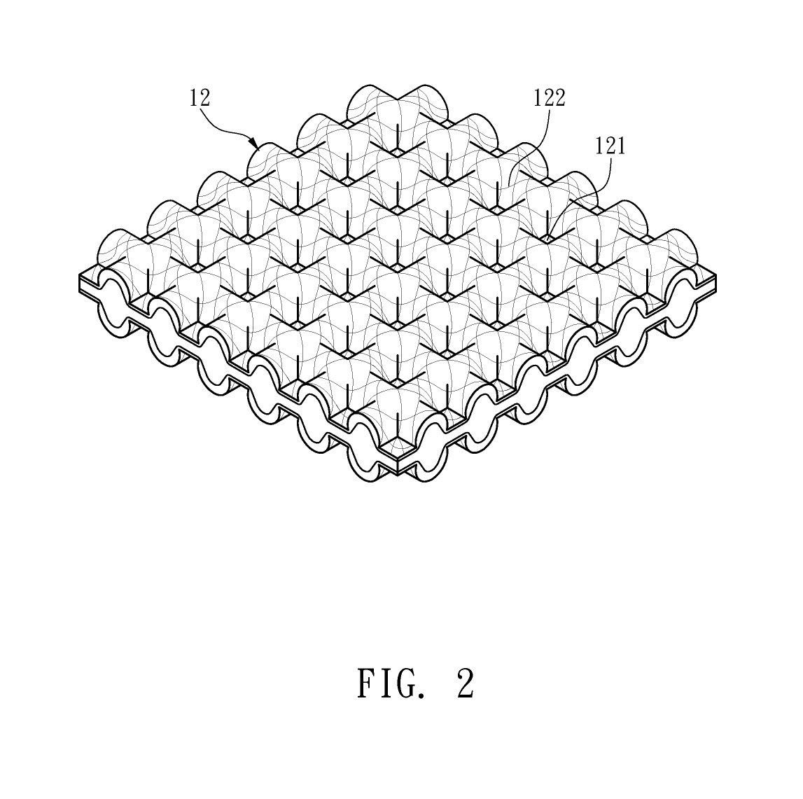

With reference to FIG. 1 for a flow chart of a manufacturing method of 3D patterned foam sheet in accordance with the first preferred embodiment of the present invention, comprises the following steps:
a. Forming procedure: foaming material 11 is placed in a foaming mold 21 for the foaming process, in this preferred embodiment, the foaming material 11 in the foaming mold 21 consists of three different forming materials 21 piled up together, the forming material 11 are in different color and hardness based on requirements. A forming space 22 is inside the forming mold 21, the foaming mold 21 has lines 23 in a predetermined pattern formed on upper and lower walls of the foaming space 22, such that after the foaming material 11 is formed, the foam sheet 12 with the lines in a predetermined pattern can be produced.
b. Compress and shaping procedure: the formed and not fully cool form sheet 12 is removed from the forming mold 21, and is compressed with a pair of matching molds 31, the matching molds 31 consist of an upper mold 32 and a lower mold 33; the upper mold 32 and lower mold 33 have some cooling water paths 321, 331 as a cooling system; the form sheet 12 is place between the upper and lower molds 32, 33. Between the upper and lower molds 32, 33 and toward the direction of form sheet 12, a plurality number of predetermined pattern convex 322, 332 are installed on the upper and lower mold 32, 33. In this preferred embodiment, the predetermined pattern convex 322, 332 on the upper and lower mold 32, 33 face each other and are in square pillar shape, while form sheet 12 is compressed by the matching mold 31, the matching mold 31 twists the lines on the surfaces of the form sheet 12 at the same time, and forms square grooves 121 on both surfaces of the form sheet 12 corresponding to the shapes of the predetermined pattern convex 322, 332 on the upper and lower mold 32, 33, also forms crossing ribs and fine the lines 122 on the surface of the ribs. (As shown in FIG. 2), these fine lines 122 substantially enhance anti-slippery effect of the form sheet 12.

The preferred embodiment in accordance to the present invention produces form sheet 12 with 3D square grooves 121 and fine lines 122 on both sides with simple method, and low cost. Different colors and hardness requirements are also available for consumer to apply both sides in turn. The form sheet 12 can be compressed before cool down such that makes the form sheet 12 has excellent fabricability.

Furthermore, the matching molds 31 are made of die casting iron, the upper mold 32 and lower mold 33 have some cooling water paths 321, 331 as a cooling system; while matching mold 31 compresses form sheet 12, cooling system can do a fast cooling action, such that sticky condition is not easy to occur while form sheet 12 is compressed and further assures the completeness of surface.

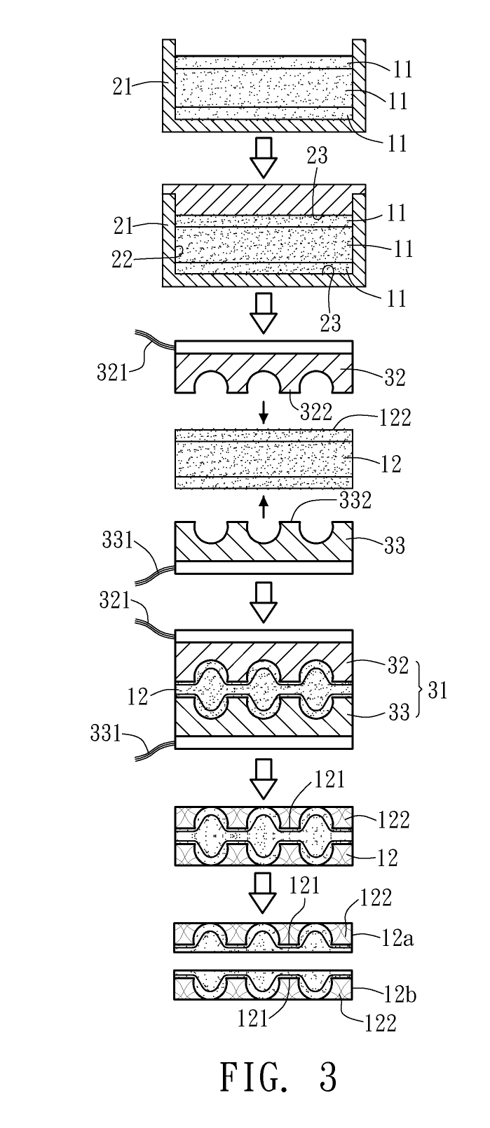

With reference to FIG. 3 for a flow chart of a manufacturing method of 3D patterned foam sheet in accordance with the second preferred embodiment of the present invention; the difference of the first preferred embodiment is: after a. forming procedure and b. compress and shaping procedure, a subsequent c. procedure follows: remove form sheet 12 after procedure b. from matching mold 31, a subsequent trim procedure is to cut the form sheet 12 from center into two form sheets 12a, 12b with a cutting tool (not shown in Fig.) for a form sheet 12 product with predetermined pattern and fine lines on single side to achieve rapid manufacturing purpose.

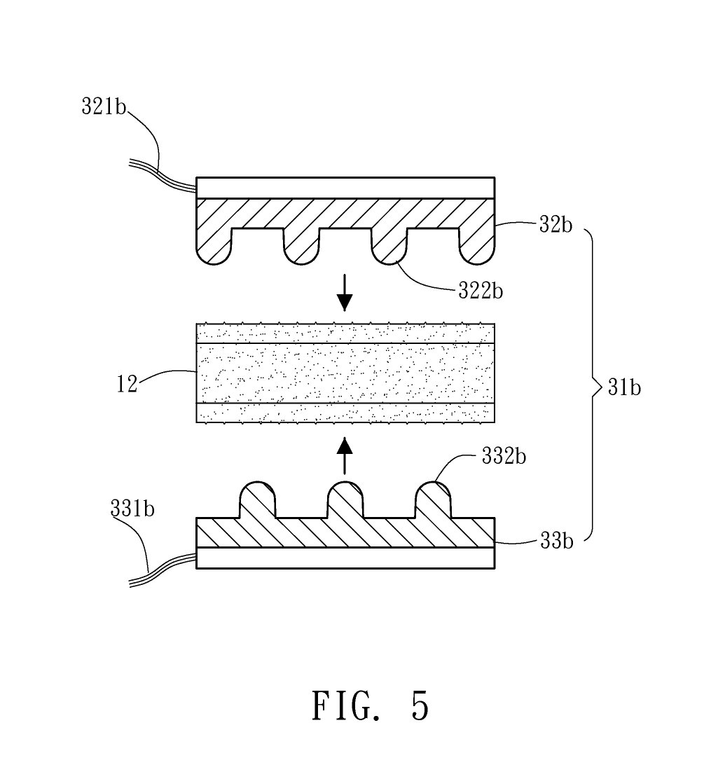

The matching mold of the third preferred embodiment of the present invention can be in different shapes as required, as shown in FIG. 5, the matching mold 31b has round pillar convex 322b, 332b, while form sheet 12 is compressed by the matching mold 31b, the matching mold 31b twists the lines on the surfaces of the form sheet 12 at the same time, and forms round grooves 121 on both surfaces of the form sheet 12 corresponding to the shapes of the predetermined pattern convex 322b, 332b.

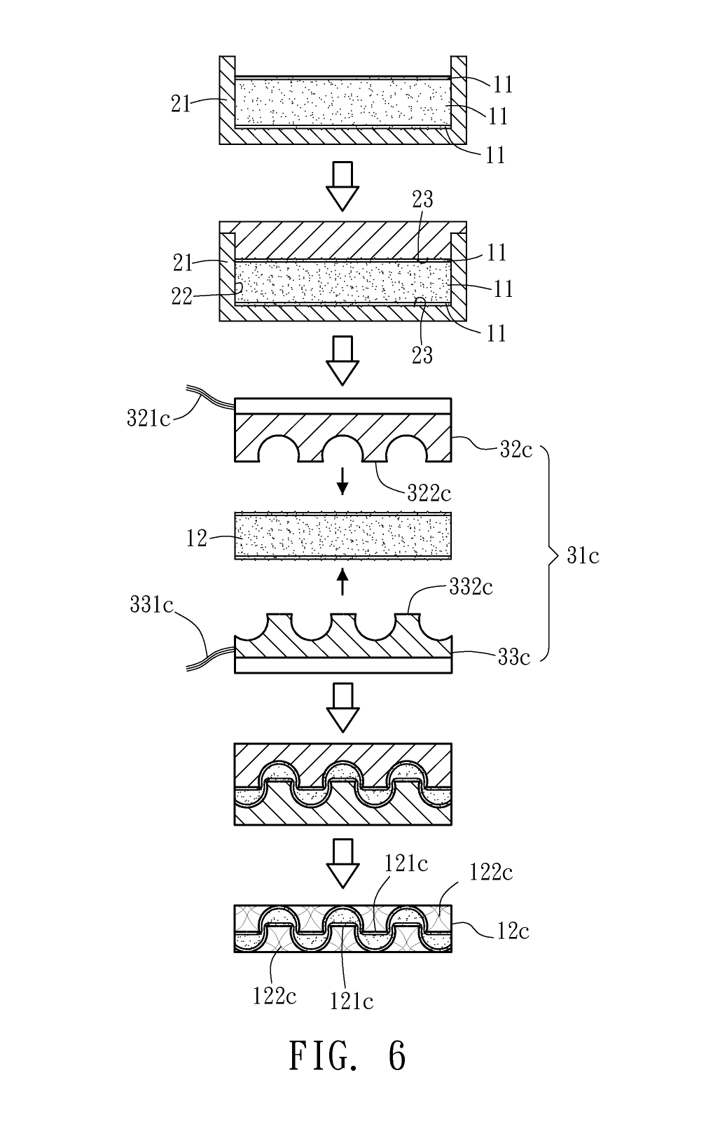

FIG. 6 is a flow chart of a manufacturing method of 3D patterned foam sheet in accordance with the third preferred embodiment of the present invention; the difference of the first preferred embodiment is: the predetermined pattern convex 322c of matching mold 31c are arranged to interleave with each other, the distance of upper and lower mold 32c, 33c of matching mold 31c is shorter, such that the thinner form sheet 12c with pattern 121c and fine lines 122c on both sides can be produced.

What is claimed is:

1. A manufacturing method of 3D patterned foam sheet, comprising the steps of:
a. forming procedure: foaming material is placed in a foaming mold for the foaming process, a forming space with lines in a predetermined pattern formed on upper and lower walls in inside said forming mold, such that after the foaming material is formed, the foam sheet with the lines in a predetermined pattern can be produced;
b. compress and shaping procedure: said formed and not fully cool form sheet is removed from said forming mold, and is compressed with a pair of matching molds, the molds have predetermined convex on the contact surfaces with said form sheet, the pattern formed on said foam sheet is twisted, and a 3D stylish model with a shape matched to the shape of said matching mold is formed on the surface said foam sheet.

2. The manufacturing method of 3D patterned foam sheet of claim 1, wherein said forming material contains more than two forming materials.

3. The manufacturing method of 3D patterned foam sheet of claim 2, wherein said forming materials have different colors.

4. The manufacturing method of 3D patterned foam sheet of claim 2, wherein said forming materials have different hardness.

5. The manufacturing method of 3D patterned foam sheet of claim 1, wherein said matching molds consist an upper and a lower mold, said form sheet is place between said upper and lower molds, a plurality number of predetermined pattern convex are installed on said upper and lower mold between said upper and lower molds and toward the direction of said form sheet.

6. The manufacturing method of 3D patterned foam sheet of claim 5, wherein said upper mold and lower mold have some cooling water paths as a cooling system.

7. The manufacturing method of 3D patterned foam sheet of claim 5, wherein after said a. forming procedure and said b. compress and shaping procedure, a subsequent trim c. procedure follows: remove said form sheet from said matching mold, and cut said form sheet from center into two form sheets with a cutting tool.

8. The manufacturing method of 3D patterned foam sheet of claim 5, wherein said predetermined pattern convex on said upper and lower mold are installed facing each other.

9. The manufacturing method of 3D patterned foam sheet of claim 5, wherein said predetermined pattern convex on said upper and lower mold are installed interleaved with each other.
